(19) United States
(12) Patent Application Publication
(10) Pub. No.: US 2009/0182857 A1
(43) Pub. Date: Jul. 16, 2009

(54) Method And System For Protocol Operation For Intelligent Controllers

(76) Inventor: Scott Krig, Santa Clara, CA (US)

Correspondence Address: MCANDREWS HELD & MALLOY, LTD, 500 WEST MADISON STREET, SUITE 3400, CHICAGO, IL, 60661, US

(21) Appl. No.: 12/195,237

(22) Filed: Aug. 20, 2008

Related U.S. Application Data
(60) Provisional application No. 61/021,476, filed on Jan. 16, 2008.
(60) Provisional application No. 61/081,451, filed on Jul. 17, 2008.

(51) Int. Cl. G06F 15/163

(52) U.S. Cl. 709/223

(57) ABSTRACT

A controller object within a communication device may process one or more objects and/or enable consumption of media content specified by said one or more objects according to a protocol extension such as an extension of the MTP. The protocol extension may comprise operations, datasets, objects and/or object properties. The controller may be launched and/or may process an object, and/or may enable consumption of media content specified by an object upon receiving an operation from a second device comprising object Ids corresponding to the object. Object properties corresponding to the controller object may identify the controller object and/or may indicate controller object launch parameters and/or controller object capabilities. Object properties corresponding to objects to be processed and/or consumed may indicate how the object should be launched, processed and/or consumed.

### CROSS-REFERENCE TO RELATED APPLICATIONS/INCORPORATION BY REFERENCE

This application makes reference to, claims priority to, and claims the benefit of U.S. Provisional Application Ser. No. 61/021,476, filed on Jan. 16, 2008, entitled “METHOD AND SYSTEM FOR PROTOCOL OPERATION FOR INTELLIGENT CONTROLLERS,” which is hereby incorporated herein by reference in its entirety.

This application makes reference to, claims priority to, and claims the benefit of U.S. Provisional Application Ser. No. 61/081,451, filed on Jul. 17, 2008, entitled “METHOD AND SYSTEM FOR PROTOCOL OPERATION FOR INTELLIGENT CONTROLLERS,” which is hereby incorporated herein by reference in its entirety.

### FIELD OF THE INVENTION

Certain embodiments of the invention relate to multimedia communication. More specifically, certain embodiments of the invention relate to a method and system for protocol operation for intelligent controllers.

### BACKGROUND OF THE INVENTION

The media transfer protocol (MTP) is an extension of the industry standard picture transfer protocol (PTP). The media transfer protocol was created as an extension to the picture transfer protocol specifically for media devices and includes various provisions for digital rights management (DRM).

Digital rights management (DRM) and electronic license management technologies may be utilized for home video, music, consumer and enterprise software markets. Motion picture studios, cable and satellite TV operators, consumer electronics companies and personal computer manufacturers use DRM technologies to prevent the unauthorized duplication, reception or use of copyrighted video materials.

PIMA 15740:2000 provides a common communication mechanism for exchanging images with and between digital still photography devices (DSPDs). This includes communication between digital still photography devices and host computers, printers, other digital still devices, telecommunications kiosks, and image storage and display devices. This standard presents a protocol that is intended to be transport and platform independent.

Further limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

A system and/or method for protocol operation for intelligent controllers, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram of exemplary devices enabled to process data by a controller utilizing MTP and/or an extension of the MTP standard, in accordance with an embodiment of the invention.

FIG. 2 is a block diagram of exemplary media devices enabled to consume media files based on MTP and/or an extension of the MTP standard, in accordance with an embodiment of the invention.

FIG. 3 is a flow chart illustrating exemplary steps for processing and/or rendering media files utilizing MTP and/or an extension of the MTP, in accordance with an embodiment of the invention.

FIG. 4 is a flow chart illustrating exemplary steps for processing and/or rendering an object utilizing a DragAndDrop operation, in accordance with an embodiment of the invention.

### DETAILED DESCRIPTION OF THE INVENTION

Aspects of the invention may be found in a method and system for protocol operation for intelligent controllers. In certain embodiments of the invention, a communication device enabled to communicate based on media transfer protocol (MTP) may process and/or consume information associated with one or more objects. The objects may comprise one or more of data, metadata and reference data. A controller object within the communication device may process and/or consume information associated with the objects according to an extension of the MTP. The MTP extension may comprise, for example, one or more of operations, datasets, objects and/or object properties.

In various embodiments of the invention, the communication device may be enabled to handle and/or process one or more objects, for example, one or more controller objects, and also the consumption of information related to the one or more controller objects. An MTP initiator device may be operable to send the one or more MTP extension operations to the communication device. Upon receiving the one or more operations, the communication device may initiate the processing of the one or more objects and/or consuming of information associated with the one or more objects. In this regard, the one or more received operations may comprise a dataset comprising one or more object identifiers (Ids). The object identifiers may indicate which object should be processed and/or consumed by the device. Moreover, the controller object may be identified by one or more object properties corresponding to the controller object.

In addition, one or more object properties corresponding to the controller object may indicate controller object launch parameters and/or controller object capabilities. Notwithstanding, object properties corresponding to the one or more objects to be processed and/or handled by the controller, may indicate how the object should be launched, processed and/or handled. For example, object properties corresponding to an object comprising a media file may indicate how the media file content should be rendered by the controller and device.

In this manner, an extension of the MTP may enable a controller on a first device to launch and to process and/or handle a specified object upon receiving an MTP operation from a second device. In an exemplary embodiment of the invention, a second device may send to a media player, an operation comprising an object identifier corresponding to an audio file stored on the media player. Upon reception of the operation, a controller object on the media player may launch and the media player may consume or render the identified audio file.

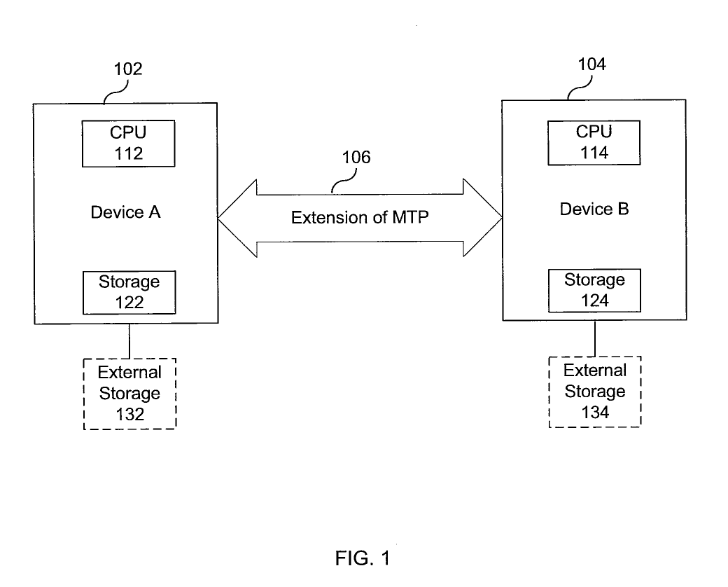

FIG. 1 is a block diagram of exemplary devices enabled to process data by a controller utilizing MTP and/or an extension of the MTP standard, in accordance with an embodiment of the invention. Referring to FIG. 1 there is shown an extension of the media transfer protocol (MTP) 106 that may facilitate secure communication between a device 102 and a device 104. The devices 102 and 104 may comprise processors 112 and 114 respectively, internal storage 122 and 124 respectively and/or external storage 132 and 134 respectively.

The device 102 may comprise suitable logic, circuitry and/or code that may enable transfer of information to and/or from the device 104 via MTP and/or an extension of the MTP 106. The device 102 may be communicatively coupled with the device 104. In addition, the device 102 may comprise suitable processing 112 and storage capacity 122 and/or 132 for generating, processing, rendering and/or communicating binary objects and/or object properties to the device 104. Moreover, the device 102 may be enabled to function as an initiator device with regard to MTP operations. The device 102 may be for example, a computing device and/or portable device. In addition, the device 102 may be a still or video digital camera, a portable media player, a cell phone or computing device. In various embodiments of the invention, the device 104 may enable marking MTP objects with one or more object properties and/or communicating objects and/or object property information with the device 104.

The device 104 may comprise suitable logic, circuitry, and/or code that may enable transfer of information to and/or from the device 102 via MTP and/or an extension of the MTP 106. The device 104 may comprise suitable processing 114 and storage capacity 124 and/or 134 for generating, processing, rendering and/or communicating binary objects and/or object properties to the device 102. Moreover, the device 104 may be enabled to function as a responder device with regard to MTP operations. For example, the device 104 may be a still or video digital camera, a portable media player, a cell phone or computing device. In various embodiments of the invention, the device 104 may enable marking MTP objects with one or more object properties and/or communicating objects and/or object property information with the device 102.

The extension of the MTP 106 may comprise modified specifications within the MTP architecture. In addition, the extension of the MTP 106 may enable processing, by a controller that may be specified by or as an MTP object. Accordingly, the MTP objects may comprise binary data, corresponding metadata and/or object refererence data. The binary data may be representative of multimedia content. In this regard, the binary data may comprise, for example, audio and/or video files, text files, programs, scheduled events, commands, profiles or application specific information. The meta data may comprise one or more object properties that conveys information about the corresponding object. In this regard, various embodiments of the invention may enable specifying the objects for processing, activation of the processing as well as providing information about how to process the objects. The objects to be processed may be specified within an MTP operation comprising corresponding object IDs sent to a device comprising the MTP controller object. The MTP operation may act as a command to activate the controller and/or to process the specified objects. Object properties associated with the object as well as object properties associated with the controller may determine how the processing may be performed.

In various embodiments of the invention a DragAndDrop operation, illustrated in Table 1, may enable an MTP initiator device to send one or more ObjectIDs to an MTP responder device to activate processing of one or more corresponding objects. The ObjectIDs may be specified by range or by value utilizing an ObjectID dataset. One or more rules or directives for how the controller may process the objects may be specified in object properties associated with the one or more objects as well as object properties associated with the controller. In various embodiments of the invention, the DragAndDrop operation may identify media objects and may activate rendering of the media objects on a media player comprising the controller, for example.

TABLE 1
DragAndDrop Operation

| | |
|---|---|
| Operation Code | 0xXXXX |
| Operation Parameter 1 | Controller ObjectID |
| Operation Parameter 2 | None |
| Operation Parameter 3 | None |
| Operation Parameter 4 | None |
| Operation Parameter 5 | None |
| Data | ObjectID Dataset |
| Data Direction | I->R |
| ResponseCode Options | OK, |
| | Parameter_Not_Supported, |
| | Invalid_Parameter |
| Response Parameter 1 | None |
| Response Parameter 2 | None |
| Response Parameter 3 | None |
| Response Parameter 4 | None |
| Response Parameter 5 | None |

An ObjectID dataset shown in Table 2, may be utilized to identify objects. For example, an objectID data set may be utilized within a data field of a DragAndDrop operation to specify one or more objects that may be processed by a controller. The ObjectIDArray may describe a range of values or one or more specified values. For example, a range of ObjectIDs within the ObjectID dataset may be specified in the following manner:

Array [0]=n

Array [1]=0

Array [3]=n+m

where n may represent the lowest value within the range of ObjectIDs, 0 may represent a hyphen and n+m may represent the greatest value within the range of ObjectIDs. Moreover, an array of individual ObjectIDs within the ObjectID dataset may be represented in the following exemplary manner.

Array[0]=0x12099ff

Array[1]=0x388

Array[3]=0xffe45

TABLE 2
ObjectID Dataset

| | Field | Size | | |
|---|---|---|---|---|
| Field name | order | (bytes) | Datatype | Description |
| ObjectIDArray | 1 | variable | AUINT32 | Array of Object IDs |

A Controller property shown in Table 3, may mark an object as a controller and may have a name represented as a string.

TABLE 3
Controller Property

| | Field | Size | | |
|---|---|---|---|---|
| Field name | order | (bytes) | Datatype | Value |
| PropertyCode | 1 | 2 | UINT16 | 0xDXXX |
| Datatype | 2 | 2 | UINT16 | 0x4002 (AUINT8) |
| Get/Set | 3 | 1 | UINT8 | 0x01 (GET/SET) |
| DefaultValue | 4 | | | 0x00 (Controller Property |
| | | | | String Name) |
| GroupCode | 5 | 4 | UINT32 | Device-defined |
| FormFlag | 6 | 1 | UINT8 | 0x00 None |

A ControllerLaunch property shown in Table 4, may be utilized to mark a controller object to specify parameters for launching the controller object. For example, the parameters from this property may be utilized when the controller is executed. The invention is not limited to any specific parameters and may utilize any suitable parameters. Exemplary parameters may comprise a set of command line parameters such as switches and/or DLLs to load. For example, -dll screen.dll, -dll driver.dll and/or -logfile sys.log may be utilized.

TABLE 4
ControllerLaunch Property

| | Field | Size | | |
|---|---|---|---|---|
| Field name | order | (bytes) | Datatype | Value |
| PropertyCode | 1 | 2 | UINT16 | 0xDXXX |
| Datatype | 2 | 2 | UINT16 | 0x4002 (AUINT8) |
| Get/Set | 3 | 1 | UINT8 | 0x01 (GET/SET) |
| DefaultValue | 4 | | | 0x00 (Null String) |
| GroupCode | 5 | 4 | UINT32 | Device-defined |
| FormFlag | 6 | 1 | UINT8 | 0x00 None |

A DragAndDrop property shown in Table 5 may indicate processing capabilities of a corresponding controller object. In this regard, the controller object may process objects and/or properties when the controller object receives a DragAndDrop operation. The invention is not limited to any specific type of controller capabilities and may utilize any suitable controller capabilities. For example, the DragAndDrop property may indicate one or more types of objects and/or properties the controller may accept for processing.

TABLE 5
DragAndDrop Property

| | Field | Size | | |
|---|---|---|---|---|
| Field name | order | (bytes) | Datatype | Value |
| PropertyCode | 1 | 2 | UINT16 | 0xDXXX |
| Datatype | 2 | 2 | UINT16 | 0x4002 (AUINT8) |
| Get/Set | 3 | 1 | UINT8 | 0x01 (GET/SET) |
| DefaultValue | 4 | | | 0x00 (Null String) |
| GroupCode | 5 | 4 | UINT32 | Device-defined |
| FormFlag | 6 | 1 | UINT8 | 0x00 None |

In addition to properties associated with controller objects, the MTP extension 106 may comprise object properties associated with objects that may be processed by the controllers.

A DragAndDropLaunchInstructions property shown in Table 6 may specify launch parameters for processing an object and/or property by a controller. This property may be attached to an object to specify how a controller object should launch, consume or render the object. The invention is not limited to any specific type of launch paratmer and may utilize any suitable launch parameters. For example, a set of command line parameters such as switches and/or DLLs to load may be specified. More specifically, for example, “-fast -use_pragmas” and/or “-low_resolution” may be utilized as a launch parameter, as required by a controller object.

TABLE 6
DragAndDropLaunchInstructions Property

| | Field | Size | | |
|---|---|---|---|---|
| Field name | order | (bytes) | Datatype | Value |
| PropertyCode | 1 | 2 | UINT16 | 0xDXXX |
| Datatype | 2 | 2 | UINT16 | 0x4002 (AUINT8) |
| Get/Set | 3 | 1 | UINT8 | 0x01 (GET/SET) |
| DefaultValue | 4 | | | 0x00 (Null String) |
| GroupCode | 5 | 4 | UINT32 | Device-defined |
| FormFlag | 6 | 1 | UINT8 | 0x00 None |

In operation, the device 102 and/or device 104 may be enabled to exchange information based on MTP and/or MTP extension 106. In this regard, one or both devices 102 and/or 104 may comprise a controller that may be defined as an MTP object and/or one or more object properties. In addition, the controller may comprise application specific logic that may be enabled to perform one or more functions. For example, one or more controllers may be enabled to send or receive commands or operations, send or receive responses and/or process objects that may comprise data, metadata and/or reference data. Exemplary objects may comprise media data such as image, video and/or audio data, text, programs, scheduled events, commands, profiles, application specific data or other types of data.

In various embodiments of the invention, the device 104 may comprise a controller object and/or one or more objects that may be processed by the controller object. The device 102 may send to the controller object on the device 104 a DragAndDrop operation comprising an ObjectID dataset. The ObjectID dataset may identify object IDs corresponding to one or more of the objects residing on the device 104. Accordingly, the one or more identified objects and corresponding object properties may be processed by the controller object residing on the device 104. In this regard, the DragAndDropLaunchInstruction object property corresponding to the identified objects as well as controller object properties such as the controller property, ControllerLaunch property and DragAndDrop property may enable activation of processing the identified objects and may determine various aspects of the processing.

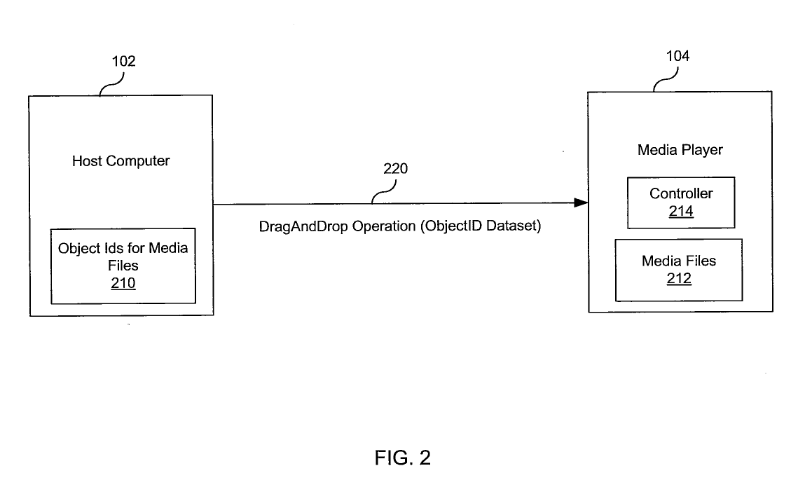

FIG. 2 is a block diagram of exemplary media devices enabled to consume media files based on MTP and/or an extension of the MTP standard, in accordance with an embodiment of the invention. Referring to FIG. 2, there is shown, the device 102, the device 104, object IDs 210, controller 212, media files 214 and a DragAndDrop operation 220.

The devices 102 and 104 may be communicatively coupled and may be similar or substantially the same as the devices 102 and 104 described in FIG. 1. For example, the device 102 may be a host computer and the device 104 may be a media player. The object IDs 212 may be stored on or may be entered by a user into the device 102. In addition, the object IDs 212 may identify corresponding objects comprising media files 212 which may reside in device 104 or may be accesible to the device 104.

The controller 214 may be defined by and/or executed utilizing one or more MTP objects, object properties, operations and datasets. The controller 214 may be enabled to receive MTP operations or commands, send responses and/or process objects. In this regard, the controller 214 may comprise application specific logic which may perform a defined set of functions for processing and/or playing the media files 212. In some embodiments of the invention the controller 214 may be defined as a device property.

The DragAndDrop operation 220 may be similar or substantially the same as the DragAndDrop operation described in FIG. 1 for the MTP extension 106. In this regard, the DragandDrop operation 220 may be sent from the device 102 to the device 104 and may comprise an ObjectID dataset. The objectID dataset may comprise object IDs corresponding to the object IDs 210.

In operation, the device 102 may be, for example, a host computing device, and the device 104 may be, for example, a handheld media player communicatively coupled to the device 102. In this regard, the invention may not be limited to any specific type of device 102 and/or 104 and may comprise any suitable type of device enabled to communicate utilizing MTP and/or an extension of the MTP 106. The device 104 may comprise a controller 214 which may be enabled to process and/or render media files 212. In addition, the device 104 may comprise a plurality of objects comprising the media files 212. In order to play one or more of the media files 212, a DragAndDrop operation 220 that may comprise an ObjectID dataset identifying the one or more media files 212, may be sent from the device 102 to the device 104. Upon reception of the DragandDrop operation 220, the controller 214 may be activated and may process and/or render the one or more media files 212 based on information within object properties corresponding to the one or more media files 212 and/or corresponding to the controller 214. For example, the properties described in FIG. 1 such as DragAndDropLaunchInstructions, Controller, ControllerLaunch and/or DragAndDrop properties may be utilized to process and/or render the media files 212.

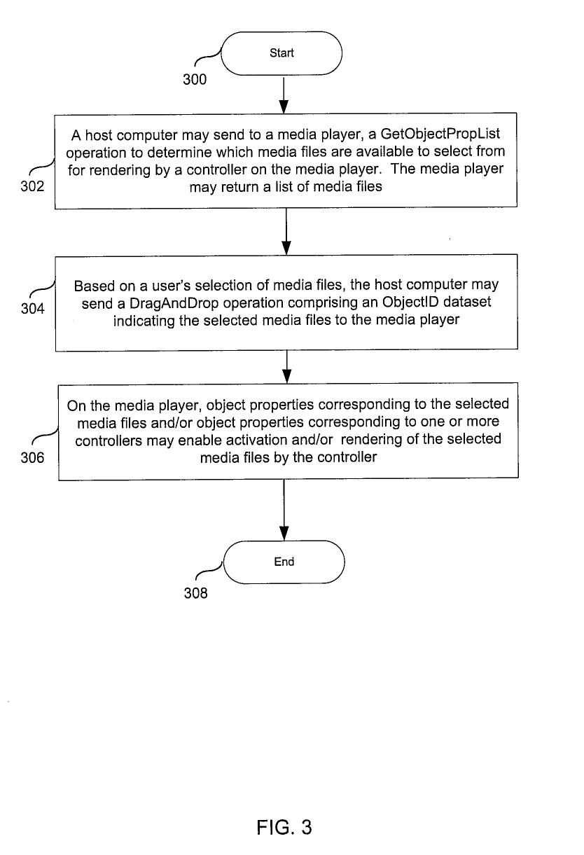

FIG. 3 is a flow chart illustrating exemplary steps for processing and/or rendering media files utilizing MTP and/or an extension of the MTP, in accordance with an embodiment of the invention. Referring to FIG. 3, after start step 300, in step 302, a host computer device 102 may send to a media player device 104, a GetObjectPropList to determine which media files 212 are available to select from for rendering by a controller 214 on the media player device 104. The media player device 104 may return a list of media files 212. In step 304, based on a user's selection of media files 212, the host computer device 102 may send to the media player device 104, a DragAndDrop operation comprising an ObjectID dataset indicating which media files 212 were selected. In step 308, on the media player device 104, object properties corresponding to the selected media files 212 and/or object properties corresponding to one or more controllers 214 may enable activation and/or rendering of the selected media files 212 by the controller 214. Step 310 may be the end of the exemplary steps.

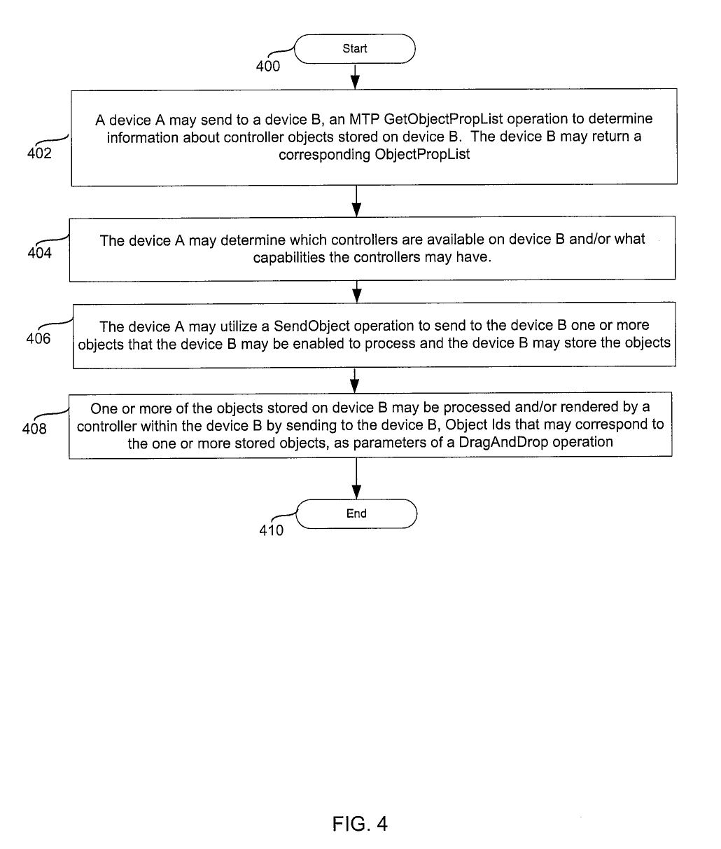

FIG. 4 is a flow chart illustrating exemplary steps for processing and/or rendering an object utilizing a DragAndDrop operation, in accordance with an embodiment of the invention. Referring to FIG. 4, after start step 400, in step 402, a device A 102 may send to a device B 104, an MTP GetObjectPropList operation to determine information about controller objects such as the controller 212, stored on device B 104. The device B 104 may return a corresponding ObjectPropList. In step 404, the device A 102 may determine which controllers are available on the device B 104 and/or what capabilities the controllers may have. In step 406, the device A 102 may utilize a SendObject operation to send to the device B 104 one or more objects that the device B 104 may be enabled to process and the device B 104 may store the objects. In step 408, one or more of the objects stored on the device B 104 may be processed and/or rendered by a controller within the device B 104 by sending to the device B 104, one or more Object Ids that may correspond to the one or more stored objects, as parameters of a DragAndDrop operation. Step 412 may be the end of the exemplary steps.

In an embodiment of the invention, a communication device 104 that may be enabled to communicate based on media transfer protocol (MTP) may process and/or consume one or more objects, for example objects comprising media files 212. The objects may comprise one or more of data, metadata and reference data. A controller object 214 within the communication device 104 may enable processing and/or consumption of the objects according to an extension of the MTP 106. The MTP extension 106 may comprise, for example, one or more of operations, datasets, objects and object properties. In various embodiments of the invention, the communication device 104 may comprise one or more objects to be processed and/or consumed, for example, media files 212 and/or one or more controller objects 214. An MTP initiator device 102 may send the one or more operations to the communication device 104. Upon receiving the one or more operations, the communication device 104 may initiate the processing of the one or more objects and/or consuming of media content specified by the objects. In this regard, the one or more received operations may comprise a dataset comprising one or more object Ids, for example, the object Ids 210. The object Ids may indicate which object to process and/or consume. Moreover, the controller object 214 may be identified by one or more object properties corresponding to the controller object 214. In addition, one or more object properties corresponding to the controller object 214 may indicate controller object 214 launch parameters and/or controller object 214 capabilities. Notwithstanding, object properties corresponding to the one or more objects to be processed and/or consumed, for example, media files 212, may indicate how the object should be launched, processed and/or consumed. In this manner, the extension of the MTP 106 may enable a controller 214 on a first device 104 to launch and/or an object 212 by sending an MTP operation from a second device 102 to the first device 104. Based on the launching and/or processing, the first device 104 may render or consume.media content.

Another embodiment of the invention may provide a machine and/or computer readable storage and/or medium, having stored thereon, a machine code and/or a computer program having at least one code section executable by a machine and/or a computer, thereby causing the machine and/or computer to perform the steps as described herein for specifying a method and system for protocol operation for intelligent controllers.

Accordingly, aspects of the invention may be realized in hardware, software, firmware or a combination thereof. The invention may be realized in a centralized fashion in at least one computer system or in a distributed fashion where different elements are spread across several interconnected computer systems. Any kind of computer system or other apparatus adapted for carrying out the methods described herein is suited. A typical combination of hardware, software and firmware may be a general-purpose computer system with a computer program that, when being loaded and executed, controls the computer system such that it carries out the methods described herein.

One embodiment of the present invention may be implemented as a board level product, as a single chip, application specific integrated circuit (ASIC), or with varying levels integrated on a single chip with other portions of the system as separate components. The degree of integration of the system will primarily be determined by speed and cost considerations. Because of the sophisticated nature of modern processors, it is possible to utilize a commercially available processor, which may be implemented external to an ASIC implementation of the present system. Alternatively, if the processor is available as an ASIC core or logic block, then the commercially available processor may be implemented as part of an ASIC device with various functions implemented as firmware.

The present invention may also be embedded in a computer program product, which comprises all the features enabling the implementation of the methods described herein, and which when loaded in a computer system is able to carry out these methods. Computer program in the present context may mean, for example, any expression, in any language, code or notation, of a set of instructions intended to cause a system having an information processing capability to perform a particular function either directly or after either or both of the following: a) conversion to another language, code or notation; b) reproduction in a different material form. However, other meanings of computer program within the understanding of those skilled in the art are also contemplated by the present invention.

While the invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiments disclosed, but that the present invention will include all embodiments falling within the scope of the appended claims.

What is claimed is:

1. A method for handling multimedia information, the method comprising:
within a communication device enabled to communicate based on media transfer protocol (MTP), processing one or more objects by a controller object to enable consumption of media content specified by said one or more objects, wherein said processing and/or said consumption are managed utilizing an extension of said MTP comprising one or more of operations, datasets, objects and/or object properties.

2. The method according to claim 1, wherein said one or more objects comprises data, metadata and/or reference data.

3. The method according to claim 1, wherein said one or more objects to be processed and/or consumed are stored within said communication device.

4. The method according to claim 1, wherein said one or more controller objects are stored within said communication device.

5. The method according to claim 1, comprising receiving said one or more operations by said communication device from an MTP initiator device.

6. The method according to claim 1, comprising receiving said one or more operations at said communication device.

7. The method according to claim 6, comprising initiating said processing and/or consumption in accordance with said one or more operations at said communication device.

8. The method according to claim 1, wherein said one or more operations comprise a dataset.

9. The method according to claim 8, wherein said dataset comprises one or more Object Ids that indicate which of said one or more objects to process and/or consume.

10. The method according to claim 1, wherein said one or more object properties identifies said controller object as a controller object.

11. The method according to claim 1, wherein said one or more object properties corresponding to said controller object indicates launch parameters for said controller object.

12. The method according to claim 1, wherein said one or more object properties corresponding to said controller object indicates said controller object's capabilities.

13. The method according to claim 1, wherein said one or more object properties, corresponding to said object to be processed and/or consumed, indicates how said object should be launched, processed and/or consumed.

14. A system for handling multimedia information, the system comprising:
one or more processors within a communication device enabled to communicate based on media transfer protocol (MTP), said one or more processors operable to process one or more objects by a controller object to enable consumption of media content specified by said one or more objects, wherein said processing and/or said consumption are managed utilizing an extension of said MTP comprising one or more of operations, datasets, objects and/or object properties.

15. The system according to claim 14, wherein said one or more objects comprises data, metadata and/or reference data.

16. The system according to claim 14, wherein said one or more objects to be processed and/or consumed are stored within said communication device.

17. The system according to claim 14, wherein said one or more controller objects are stored within said communication device.

18. The system according to claim 14, wherein said one or more processors enable reception of said one or more operations by said communication device from an MTP initiator device.

19. The system according to claim 14, wherein said one or more processors enable reception of said one or more operations at said communication device.

20. The system according to claim 19, wherein said one or more processors enable initiating said processing and/or consumption in accordance with said one or more operations at said communication device.

21. The system according to claim 14, wherein said one or more operations comprise a dataset.

22. The system according to claim 21, wherein said dataset comprises one or more Object Ids that indicate which of said one or more objects to process and/or consume.

23. The system according to claim 14, wherein said one or more object properties identifies said controller object as a controller object.

24. The system according to claim 14, wherein said one or more object properties corresponding to said controller object indicates launch parameters for said controller object.

25. The system according to claim 14, wherein said one or more object properties corresponding to said controller object indicates said controller object's capabilities.

26. The system according to claim 14, wherein said one or more object properties, corresponding to said object to be processed and/or consumed, indicates how said object should be launched, processed and/or consumed.
